(19) United States
(12) Patent Application Publication
(10) Pub. No.: US 2020/0296706 A1
(43) Pub. Date: Sep. 17, 2020

(54) Method for Preempting Resource to Transmit Data

(71) Applicant: Huawei Technologies Co., Ltd., Shenzhen (CN)

(72) Inventors: Bai Du, Shanghai (CN); Peng Zhang, Shanghai (CN); Toufiqul Islam, Sunnyvale, CA (US); Amine Maaref, Ottawa (CA); Yongxia Lyu, Ottawa (CA)

(21) Appl. No.: 16/886,362

(22) Filed: May 28, 2020

Related U.S. Application Data
(63) Continuation of application No. PCT/CN2018/117422, filed on Nov. 26, 2018.

(30) Foreign Application Priority Data
Nov. 29, 2017 (CN) 201711230641.6

(51) Int. Cl. H04W 72/04

(52) U.S. Cl. CPC H04W 72/0406; H04W 72/0446

(57) ABSTRACT

A method includes: a terminal device may determine, based on a type of downlink control information DCI, whether data scheduled by using the DCI exists on a preempted time-frequency resource, to determine whether the data transmitted on the preempted time-frequency resource needs to participate in data decoding.

### CROSS-REFERENCE TO RELATED APPLICATIONS

This application is a continuation of International Application No. PCT/CN2018/117422, filed on Nov. 26, 2018, which claims priority to Chinese Patent Application No. 201711230641.6, filed on Nov. 29, 2017. The disclosures of the aforementioned applications are hereby incorporated by reference in their entireties.

### TECHNICAL FIELD

Embodiments of the present invention relate to the field of wireless communications, and in particular, to a method for preempting a resource to transmit data and an apparatus.

### BACKGROUND

A 5G mobile communications system supports an enhanced mobile broadband (eMBB) service, an ultra-reliable and low-latency communication (URLLC) service, and a massive machine-type communications (mMTC) service. Typical eMBB services include an ultra-high definition video, augmented reality (AR), virtual reality (VR), and the like. These services are mainly characterized by a large data transmission amount and a quite high transmission rate. Typical URLLC services include tactile interactive applications such as wireless control in an industrial manufacturing or production procedure, motion control of an unmanned vehicle and an unmanned aircraft, remote repair, and remote surgery. These services mainly characterized by ultra-high reliability, low latency, a relatively small data transmission amount, and burstiness. Typical mMTC services include power distribution automation of a smart grid, a smart city, and the like that are mainly characterized by a huge quantity of web-connected devices, a relatively small data transmission amount, and insensitivity of data to transmission latency. These mMTC terminals need to satisfy requirements for low costs and a very long standby time.

Different services have different requirements for a mobile communications system. Therefore, how to better support all data transmission requirements of a plurality of different services is one of technical problems that need to be resolved in the current 5G mobile communications system.

A data packet of a URLLC service is generated unexpectedly and randomly, and no data packet may be generated within a quite long period of time, or a plurality of data packets may be generated within a quite short period of time. In most cases, the data packet of the URLLC service is a small packet, for example, with 32 bytes or 50 bytes. A feature of the data packet of the URLLC service affects an allocation mode of a transmission resource in the communications system. The transmission resource herein includes but is not limited to a time-domain symbol, a frequency-domain resource, a time-frequency resource, a codeword resource, a beam resource, and the like. Transmission resources are usually allocated by a base station. The following uses a base station as an example for description. If the base station allocates a transmission resource to a URLLC service by reserving a resource, a reserved transmission resource is wasted when no URLLC service data needs to be transmitted. In addition, a short-latency feature of the URLLC service requires that a data packet be transmitted in an extremely short time. Therefore, the base station needs to reserve a sufficiently large bandwidth for the URLLC service, resulting in a severe decrease in transmission resource utilization.

Due to burstiness of the URLLC service data, to improve system resource utilization, the base station usually reserves no resource for downlink data transmission of the URLLC service. When the URLLC service data arrives at the base station, if there is no idle time-frequency resource, to meet an ultra-short latency requirement of the URLLC service, the base station cannot schedule the URLLC service data after a currently scheduled eMBB service data is transmitted. The base station may allocate a resource to the URLLC service data through preemption. As shown in FIG. 1, preemption herein means that a base station selects some or all of allocated time-frequency resources used to transmit eMBB service data, to transmit URLLC service data. When the URLLC service data preempts some or all of the time-frequency resources used to transmit the eMBB service data, a transmit power of the eMBB service data on the preempted time-frequency resources is set to zero, or no eMBB service data is sent on the preempted time-frequency resources. This may also be referred to as puncturing the eMBB service data or puncturing the time-frequency resources used to transmit the eMBB service data. If a terminal receiving the eMBB service data does not learn of a part of data that is affected by the preemption, the terminal may perform decoding and hybrid automatic repeat request (HARQ) combination by mistaking URLLC service data for the eMBB service data. Consequently, performance of decoding and HARQ combination on the eMBB service data is severely affected.

When the resource preemption occurs, to reduce impact of the resource preemption on the eMBB service data, the base station may send a preemption indication (PI) to the terminal that receives the eMBB service data, to notify the terminal of a preempted transmission resource. After receiving the PI, the terminal clears, from a buffer, data received on a time-frequency resource indicated by the PI, to avoid impact of URLLC service data on eMBB service data decoding, thereby improving transmission performance of the eMBB service data. The PI is carried in downlink control information (DCI), and is sent to a group of terminals by using a physical downlink control channel (PDCCH).

When a terminal supports both a URLLC service and an eMBB service, URLLC service data sent to the terminal may preempt a transmission resource used for eMBB service data of the terminal. In this case, after the terminal receives a PI, if the terminal clears, from a buffer, all data received on the time-frequency resource indicated by the PI, the URLLC service data is also cleared.

### SUMMARY

This application provides a method for preempting a resource to transmit data and an apparatus. When a time-frequency resource used to transmit second service data is preempted to transmit first service data, when receiving and processing the second service data, a terminal device may flush data received on the preempted time-frequency resource, so that the data received on the preempted time-frequency resource does not participate in decoding and/or HARQ combination of the second service data, thereby improving transmission performance of the second service data. In addition, when the terminal device receives and processes the first service data, the first service data transmitted on the preempted time-frequency resource is not flushed because of PI, so that the first service data transmitted on the preempted time-frequency resource can normally participate in decoding, thereby ensuring normal transmission of the first service data.

According to a first aspect, a method for preempting a resource to transmit data is provided. The method includes: receiving first control information, where the first control information is used to indicate that a communications apparatus receives first data on a first time-frequency resource; receiving second control information, where the second control information is used to indicate that no information is transmitted on a second time-frequency resource; and determining, based on a feature of the first control information or a feature of the first data, whether the first data exists on a third time-frequency resource, where the third time-frequency resource is an overlapped time-frequency resource of the first time-frequency resource and the second time-frequency resource. The data transmission method is executed by a communications apparatus. The communications apparatus may be a terminal device, or may be a chip or a chip group applied to a terminal device. For example, the terminal is an execution body. The terminal device determines, based on the feature of the first control information or the feature of the first data, whether the first data exists on the third time-frequency resource, and implicitly determines receiving and processing of the data on the third time-frequency resource, thereby reducing signaling overheads and improving air interface transmission efficiency.

In a possible implementation of the first aspect, it is determined that the first data exists on the third time-frequency resource when a type of the first control information is a first type; and/or it is determined that the first data does not exist on the third time-frequency resource when the type of the first control information is not the first type.

In a possible implementation of the first aspect, it is determined that the first data exists on the third time-frequency resource when a start transmission location of the first control information is not a start location of a slot.

In a possible implementation of the first aspect, it is determined that the first data exists on the third time-frequency resource when a transmission time interval for transmitting the first data is less than a first threshold; and/or it is determined that the first data does not exist on the third time-frequency resource when the transmission time interval for transmitting the first data is greater than or equal to the first threshold.

In a possible implementation of the first aspect, it is determined that the first data exists on the third time-frequency resource when the transmission time interval for transmitting the first data is less than or equal to the first threshold; and/or it is determined that the first data does not exist on the third time-frequency resource when the transmission time interval for transmitting the first data is greater than the first threshold.

In a possible implementation of the first aspect, it is determined that the first data exists on the third time-frequency resource when a subcarrier spacing for transmitting the first data is greater than a second threshold; and/or it is determined that the first data does not exist on the third time-frequency resource when the subcarrier spacing for transmitting the first data is less than or equal to the second threshold.

In a possible implementation of the first aspect, it is determined that the first data exists on the third time-frequency resource when the subcarrier spacing for transmitting the first data is greater than or equal to the second threshold. That is, receiving of the first data is not affected by PI. It is determined that the first data does not exist on the third time-frequency resource. That is, receiving of the first data is affected by the PI when the subcarrier spacing for transmitting the first data is less than the second threshold.

In a possible implementation of the first aspect, third control information is received, where the third control information is used to indicate that the communications apparatus receives third data on a fourth time-frequency resource; and the third control information includes first indication information, and the first indication information is used to indicate whether there is the first data sent to the communications apparatus on a fifth time-frequency resource, where the fifth time-frequency resource is a time-frequency resource that is of a sixth time-frequency resource and that does not overlap with the third time-frequency resource, and the sixth time-frequency resource is an overlapped time-frequency resource of the fourth time-frequency resource and the second time-frequency resource.

According to a second aspect, a method for preempting a resource to transmit data is provided. The method includes: receiving first control information, where the first control information is used to indicate that a communications apparatus receives first data on a first time-frequency resource; receiving second control information, where the second control information is used to indicate that no information is transmitted on a second time-frequency resource; and receiving third control information, where the third control information is used to indicate that the communications apparatus receives third data on a fourth time-frequency resource; and the third control information includes first indication information, and the first indication information is used to indicate whether there is the first data sent to the communications apparatus on a fifth time-frequency resource, where the fifth time-frequency resource is a non-overlapped time-frequency resource of a sixth time-frequency resource and a third time-frequency resource, the sixth time-frequency resource is an overlapped time-frequency resource of the fourth time-frequency resource and a second time-frequency resource, and the third time-frequency resource is an overlapped time-frequency resource of the first time-frequency resource and the second time-frequency resource. The data transmission method is executed by a communications apparatus. The communications apparatus may be a terminal device, or may be a chip or a chip group applied to a terminal device. For example, the terminal is an execution body. The terminal device determines, based on the first indication information, whether the terminal device has the first data on the fifth time-frequency resource, and explicitly indicates receiving and processing of the data on the fifth time-frequency resource, to avoid flushing data that can participate in decoding, thereby improving air interface transmission efficiency.

According to a third aspect, a method for preempting a resource to transmit data is provided. The method includes: receiving first control information, where the first control information is used to indicate that a communications apparatus receives first data on a first time-frequency resource; receiving third control information, where the third control information is used to indicate that the communications apparatus receives third data on a fourth time-frequency resource; and the third control information further includes first indication information, and the first indication information is used to indicate whether there is the first data sent to the communications apparatus on a fifth time-frequency resource, where time domain of the fifth time-frequency resource corresponds to overlapped time domain of the first time-frequency resource and the fourth time-frequency resource, and frequency domain of the fifth time-frequency resource corresponds to non-overlapped frequency domain of the first time-frequency resource and the fourth time-frequency resource. The data transmission method is executed by a communications apparatus. The communications apparatus may be a terminal device, or may be a chip or a chip group applied to a terminal device. For example, the terminal is an execution body. The terminal device determines, based on the first indication information, whether the terminal device has the first data on the fifth time-frequency resource, and explicitly indicates receiving and processing of the data on the fifth time-frequency resource, to avoid flushing data that can participate in decoding, thereby improving air interface transmission efficiency.

According to a fourth aspect, a method for preempting a resource to transmit data is provided. The method includes: receiving fourth control information, where the fourth control information is used to indicate that a communications apparatus receives first data on a first bandwidth part BWP; receiving first control information, where the first control information is used to indicate that the communications apparatus receives the first data on a first time-frequency resource; receiving second control information, where the second control information is used to indicate that no information is transmitted on a second time-frequency resource; and determining, based on a relationship between the second control information and the first BWP, whether the first data exists on a third time-frequency resource, where the third time-frequency resource is an overlapped time-frequency resource of the first time-frequency resource and the second time-frequency resource. The data transmission method is executed by a communications apparatus. The communications apparatus may be a terminal device, or may be a chip or a chip group applied to a terminal device. For example, the terminal is an execution body. The terminal device determines, based on the relationship between the second control information and the first BWP, whether the first data exists on the third time-frequency resource, and implicitly determines receiving and processing of the data on the third time-frequency resource, thereby reducing signaling overheads and improving air interface transmission efficiency.

In a possible implementation of the fourth aspect, it is determined that the first data does not exist on the third time-frequency resource when the second control information belongs to the first BWP; and/or it is determined that the first data exists on the third time-frequency resource when the second control information does not belong to the first BWP.

According to a fifth aspect, a communications apparatus is provided. The communications apparatus includes a processing unit and a transceiver unit, where the processing unit is configured to perform a data processing function according to any one of the first aspect or possible implementations of the first aspect, and the transceiver unit is configured to perform a data sending and receiving function according to any one of the first aspect or possible implementations of the first aspect; or the processing unit is configured to perform a data processing function according to any one of the second aspect or possible implementations of the second aspect, and the transceiver unit is configured to perform a data sending and receiving function according to any one of the second aspect or possible implementations of the second aspect; or the processing unit is configured to perform a data processing function according to any one of the third aspect or possible implementations of the third aspect, and the transceiver unit is configured to perform a data sending and receiving function according to any one of the third aspect or possible implementations of the third aspect; or the processing unit is configured to perform a data processing function according to any one of the fourth aspect or possible implementations of the fourth aspect, and the transceiver unit is configured to perform a data sending and receiving function according to any one of the fourth aspect or possible implementations of the fourth aspect.

According to a sixth aspect, a communications apparatus is provided. The communications apparatus includes a processor and a memory, where the memory is configured to store a computer program or an instruction, the processor is configured to execute the computer program or the instruction stored in the memory, and when the processor executes the computer program or the instruction stored in the memory, the communications apparatus is configured to perform the method according to any one of the first aspect or possible implementations of the first aspect; or the communications apparatus is configured to perform the method according to any one of the second aspect or possible implementations of the second aspect; or the communications apparatus is configured to perform the method according to any one of the third aspect or the possible implementations of the third aspect; or the communications apparatus is configured to perform the method according to any one of the fourth aspect or possible implementations of the fourth aspect. Components in the communications apparatus communicate with each other by using an internal connection path, for example, transfer a control and/or data signal by using a bus.

According to a seventh aspect, a communications apparatus is provided. The communications apparatus includes a processing circuit and a transceiver circuit, where the processing circuit is configured to perform a function of the processing unit according to the fifth aspect, and the transceiver circuit is configured to perform a function of the transceiver unit according to the fifth aspect. Circuits in the communications apparatus communicate with each other by using an internal circuit.

According to an eighth aspect, a computer-readable storage medium is provided. The computer-readable storage medium is configured to store a computer program or an instruction, and when the computer program or the instruction is run on a computer, the computer is enabled to perform the method according to any one of the first aspect or possible implementations of the first aspect; or the computer is enabled to perform the method according to any one of the second aspect or possible implementations of the second aspect; or the computer is enabled to perform the method according to any one of the third aspect or possible implementations of the third aspect; or the computer is enabled to perform the method according to any one of the fourth aspect or possible implementations of the fourth aspect.

According to a ninth aspect, a computer program product is provided. When the computer program product is run on a computer, the computer is enabled to perform the method according to any one of the first aspect or possible implementations of the first aspect; or the computer is enabled to perform the method according to any one of the second aspect or possible implementations of the second aspect; or the computer is enabled to perform the method according to any one of the third aspect or possible implementations of the third aspect; or the computer is enabled to perform the method according to any one of the fourth aspect or possible implementations of the fourth aspect.

### BRIEF DESCRIPTION OF THE DRAWINGS

FIG. 1 is a schematic diagram of preempting, by URLLC service data, a time-frequency resource used to transmit eMBB service data;

FIG. 2 is a schematic architecture diagram of a mobile communications system to which an embodiment of this application is applied;

FIG. 3 is a schematic diagram of a relationship among a time-frequency resource A, a time-frequency resource B, and a time-frequency resource C according to an embodiment of this application;

FIG. 4 is another schematic diagram of preempting, by URLLC service data, a time-frequency resource used to transmit eMBB service data according to an embodiment of this application;

FIG. 5 is a schematic flowchart of a method for preempting a resource to transmit data according to an embodiment of this application;

FIG. 6 is a schematic flowchart of another method for preempting a resource to transmit data according to an embodiment of this application;

FIG. 7 is a schematic flowchart of still another method for preempting a resource to transmit data according to an embodiment of this application;

FIG. 8 is still another schematic diagram of preempting, by URLLC service data, a time-frequency resource used to transmit eMBB service data according to an embodiment of this application;

FIG. 9 is a schematic flowchart of still another method for preempting a resource to transmit data according to an embodiment of this application;

FIG. 10 is a schematic structural diagram of a communications apparatus according to an embodiment of this application;

FIG. 11 is a schematic structural diagram of another communications apparatus according to an embodiment of this application; and

FIG. 12 is a schematic structural diagram of still another communications apparatus according to an embodiment of this application.

### DETAILED DESCRIPTION OF ILLUSTRATIVE EMBODIMENTS

The following describes the technical solutions in the embodiments of the present invention with reference to the accompanying drawings in the embodiments of the present invention.

FIG. 2 is a schematic architectural diagram of a mobile communications system to which an embodiment of this application is applied. As shown in FIG. 2, the mobile communications system includes a core network device 210, a radio access network device 220, and at least one terminal device (for example, a terminal device 230 and a terminal device 240 in FIG. 2). The terminal device is connected to the radio access network device in a wireless manner, and the radio access network device is connected to the core network device in a wireless or wired manner. The core network device and the radio access network device may be different independent physical devices, or a function of the core network device and a logical function of the radio access network device may be integrated into a same physical device, or a function of a part of the core network device and a function of a part of the radio access network device may be integrated into a physical device. The terminal device may be at a fixed location or may be mobile. FIG. 2 is merely a schematic diagram, and the communications system may further include another network device, for example, may further include a wireless relay device and a wireless backhaul device that are not drawn in FIG. 2. Quantities of core network devices, radio access network devices, and terminal devices included in the mobile communications system are not limited in this embodiment of this application.

The radio access network device is an access device that is connected to the mobile communications system by the terminal device in a wireless manner, and may alternatively be a base station NodeB, an evolved base station eNodeB, a base station in a 5G mobile communications system or a new radio (NR) communications system, a base station in a future mobile communications system, an access node in a Wi-Fi system, or the like. A specific technology and a specific device form used by the radio access network device are not limited in this embodiment of this application. In this application, the radio access network device is briefly referred to as a network device. Unless otherwise specified, in this application, all network devices are radio access network devices. In this application, the terms 5G and NR may be equivalent.

The terminal device may also be referred to as a terminal, user equipment (UE), a mobile station (MS), a mobile terminal (MT), or the like. The terminal device may be a mobile phone, a tablet computer (Pad), a computer with a wireless transceiver function, a virtual reality (VR) terminal device, an augmented reality (AR) terminal device, a wireless terminal in an industrial control, a wireless terminal in self driving, a wireless terminal in a remote medical surgery, a wireless terminal in a smart grid, a wireless terminal in transportation safety, a wireless terminal in a smart city, a wireless terminal in a smart home, or the like.

The radio access network device and the terminal device may be deployed on the land, including an indoor device, an outdoor device, a handheld device, or a vehicle-mounted device; may be deployed on the water; or may be deployed on an airplane, a balloon, and a satellite in the air. Application scenarios of the radio access network device and the terminal device are not limited in this embodiment of this application.

The radio access network device and the terminal device may communicate with each other by using a licensed spectrum, or may communicate with each other by using an unlicensed spectrum, or may communicate with each other by using both a licensed spectrum and an unlicensed spectrum. The radio access network device and the terminal device may communicate with each other by using a spectrum below 6 gigahertz (GHz), or may communicate with each other by using a spectrum above 6 GHz, or may communicate with each other by using both a spectrum below 6 GHz and a spectrum above 6 GHz. A spectrum resource used between the radio access network device and the terminal device is not limited in this embodiment of this application.

Downlink data transmission between a sending device that is the network device and a receiving device that is the terminal device is used as an example below for description.

When a time-frequency resource used to transmit eMBB service data is affected, the network device may send indication information for assisting in reception to the terminal device. The indication information for assisting in reception is used to notify the terminal device of an affected time-frequency region. After receiving the indication information for assisting in reception, the terminal device may flush corresponding eMBB service data that is received in the affected time-frequency region, where the eMBB service data in the region does not participate in decoding or HARQ combination, thereby improving a decoding success rate and improving data transmission efficiency.

That the time-frequency resource used to transmit eMBB service data is affected includes:

(1) The time-frequency resource used to transmit eMBB service data is preempted to transmit other service data or another signal, or is set to a reserved resource, for example, the time-frequency resource is preempted to transmit URLLC service data; or to transmit an interference management-related signal; or to be reserved for use in another system. The interference management-related signal herein may include a reference signal or a zero-power reference signal. The reserved resource herein may be reserved for use in a long term evolution (LTE) system, and is applied to a scenario in which NR and LTE coexist. For example, first three time domain symbols of a subframe may be reserved for use by a PDCCH in LTE. The reserved resource may alternatively be used to measure an NR reference signal. For example, when bandwidth parts (BWP) of two UEs partially overlap, reference signals of the two UEs may interfere with each other. In this case, a part of an overlapped time-frequency resource of the two UEs may be reserved in a resource reservation manner, to avoid interference. In a scenario in which a control channel and a data channel are multiplexed, after a part of a resource of one channel is configured as a reserved resource, the other channel can use the reserved resource. In this application, unless otherwise specified, a symbol may be equivalent to a time-domain symbol.

(2) The time-frequency resource used to transmit eMBB service data is interfered by another signal, for example, interfered by a signal of a neighboring cell.

When the time-frequency resource used to transmit the eMBB service data is affected, the network device has two different processing manners for the eMBB service data. One manner is puncturing. In this case, the eMBB service data on the affected time-frequency resource is punctured, that is, the eMBB service data is not sent on the affected time-frequency resource, or it may be understood that a transmit power of the eMBB service data on the affected time-frequency resource is set to zero. The other manner is a rate matching manner. In this case, the affected time-frequency resource does not carry the eMBB service data. When performing data mapping on the eMBB service data, the network device does not use the affected time-frequency resource as a time-frequency resource carrying the eMBB service data. When the network device processes data transmitted on the affected time-frequency resource in the puncturing manner, when receiving the eMBB service data, the terminal device may correspondingly flush the data transmitted on the affected time-frequency resource, so that the data transmitted on the affected time-frequency resource does not participate in decoding of the eMBB service data. When the network device processes the data transmitted on the affected time-frequency resource in the rate matching manner, the terminal device does not extract the data from the affected time-frequency resource when performing demodulation processing on the eMBB service data.

For the reserved resource, the network device and the terminal device usually perform processing in a rate matching manner. Therefore, the reserved resource may also be referred to as a rate matching resource (RMR).

When the time-frequency resource used to transmit the eMBB service data is preempted to transmit the URLLC service data, the indication information for assisting in reception may also be referred to as a preemption indication (PI). A specific name of the indication information for assisting in reception is not limited in this application.

It may be understood that this embodiment of this application may also be applied to another application scenario. For example, first information preempts a time-frequency resource used to transmit second information, or transmission of the first information interferes with transmission of the second information. A transmission priority of the first information is higher than that of the second information, and a transmission resource of the second information is allowed to be preempted. The application scenario is not limited in this application. The affected service data herein may be a uMTC service or another service in addition to the eMBB service. An example of the time-frequency resource that is preempted by the URLLC service data and that is used to transmit the eMBB service data is used to describe this embodiment provided in this application. However, a specific type of the service data is not limited in this embodiment of this application.

This embodiment of this application may be applied to the following two scenarios.

Scenario 1: UE 1 supports data transmission of both a URLLC service and an eMBB service, and URLLC service data of the UE 1 preempts a transmission resource used to transmit eMBB service data of UE 2. The UE 1 may be a terminal device 230 in FIG. 2, and the UE 2 may be a terminal device 240 in FIG. 2. Because the UE 1 supports data transmission of both the URLLC service and the eMBB service, the UE 1 may receive PI from a network device.

Scenario 2: UE 1 supports data transmission of both a URLLC service and an eMBB service, and URLLC service data of the UE 1 preempts a transmission resource used to transmit eMBB service data of the UE 1.

When UE supports both the URLLC service and the eMBB service, for example, the UE 1 in the foregoing scenario 1 and scenario 2, the UE may receive PI from a network device, and the PI indicates a preempted resource. After receiving the PI, how the UE determines, based on the PI, whether to flush data that is in a buffer and that is transmitted by using a time-frequency resource that overlaps a time-frequency resource indicated by the PI is a technical problem to be resolved in this application.

### Embodiment 1

In scenario 1 and scenario 2, it is assumed that a time-frequency resource allocated by the network device to the URLLC service data by using DCI_A is a time-frequency resource A, and the URLLC service data is referred to as data A; a time-frequency resource allocated by the network device to the eMBB service data by using DCI_B is a time-frequency resource B, and the eMBB service data is referred to as data B; the PI indicates that a preempted time-frequency resource is a time-frequency resource C; an overlapped time-frequency resource of the time-frequency resource A and the time-frequency resource C is a time-frequency resource D; and an overlapped time-frequency resource of the time-frequency resource B and the time-frequency resource C is a time-frequency resource E. The time-frequency resource B herein may be allocated to both the UE 2 in scenario 1 and the UE 1 in scenario 2. The DCI_A is DCI used by the network device to schedule the URLLC service data, and the DCI_B is DCI used by the network device to schedule the eMBB service data. FIG. 3 is a schematic diagram of a relationship among the time-frequency resource A, the time-frequency resource B, and the time-frequency resource C.

After the UE 1 receives the PI, the UE 1 may determine, based on a feature of the DCI_A or a feature of the data A, whether data indicated by the DCI_A exists on the time-frequency resource D. After the UE 2 receives the PI, the UE 2 may determine, based on a feature of the DCI_B or a feature of the data B, whether data indicated by the DCI_B exists on the time-frequency resource E. In scenario 2, after the UE 1 receives the PI, the UE 1 may further determine, based on the feature of the DCI_B or the feature of the data B, whether the data indicated by the DCI_B exists on the time-frequency resource E. The features of the DCI_A and the DCI_B herein include a type of the DCI or a start transmission location of the DCI. The features of the data A and the data B include a transmission time interval of transmitted data or a subcarrier spacing of transmitted data. In scenario 2, the features of the DCI_A and the DCI_B each further include a relative location for transmitting the DCI. The UE 1 may determine, based on the relative location for transmitting the DCI, whether the data A scheduled by using the DCI_A or the data B scheduled by using the DCI_B is transmitted on the time-frequency resource E. In scenario 2, the features of the data A and the data B each further include a relative location at which the data starts to be transmitted. The UE 1 may determine, based on the relative location at which the data starts to be transmitted, whether the data A scheduled by using the DCI_A or the data B scheduled by using the DCI_B is transmitted on the time-frequency resource E. In this application, the data scheduled by using the DCI may be equivalent to the data indicated by the DCI.

In scenario 2, when the UE 1 receives the DCI_A, the time-frequency resource A scheduled by using the DCI_A overlaps the time-frequency resource B scheduled by using the DCI_B. The UE 1 determines that the data A transmitted on the time-frequency resource A scheduled by using the DCI_A is not affected by the PI. The data A scheduled by using the DCI_A preempts a part or all of the time-frequency resource B that is scheduled by using the DCI_B and that is used to transmit the data B. Because a transmission delay requirement of the data A is quite low, data transmission cannot be performed after the data B is transmitted. In addition, in this case, the network device has no idle resource for use or does not have sufficient idle resources for use. Therefore, the network device allocates the time-frequency resource A to the data A by using the DCI_A, and the time-frequency resource A partially or completely overlaps the time-frequency resource B used to transmit the data B. When one UE receives two pieces of DCI in sequence and time-frequency resources scheduled by using the two pieces of DCI partially overlap, the UE may determine, by determining a sequence of receiving the DCI, whether receiving of corresponding data is affected by the PI, and a time-frequency resource used to transmit data scheduled by using DCI h preempted by DCI that is received latter. That is, receiving of data scheduled by using the DCI that is received latter is not affected by the PI, and receiving of data scheduled by using the DCI that is received earlier is affected by the PI.

In this application, that receiving of data scheduled by using a piece of DCI is affected by the PI means that after the UE receives the PI, data transmitted on an affected time-frequency resource does not participate in decoding performed by the UE on data scheduled by using the DCI. Specifically, there may be the following three implementations. (1) In the affected data transmission, data transmitted on the affected time-frequency resource still participates in decoding performed by the UE on data scheduled by using the DCI. However, the data transmitted on the affected time-frequency resource is flushed from a HARQ buffer corresponding to the data scheduled by using the DCI, and no longer participates in subsequent HARQ combination. (2) In the affected data transmission, before receiving the PI, the UE decodes all data scheduled by using the DCI. After receiving the PI, the UE performs decoding again after the UE excludes data transmitted on the affected time-frequency resource. (3) In the affected data transmission, before receiving the PI, the UE does not decode data scheduled by using the DCI. After receiving the PI, the UE performs decoding after the UE excludes data transmitted on the affected time-frequency resource. The affected time-frequency resource herein is an overlapped time-frequency resource of the preempted time-frequency resource that is indicated by the PI and the time-frequency resource that is scheduled by using the DCI. That receiving of data scheduled by using a piece of DCI is not affected by the PI means that after the UE receives the PI, the PI does not affect decoding of data scheduled by using the DCI. Decoding processing performed by the UE on the data scheduled by using the DCI is the same as processing performed when the PI is not received. Data transmitted on an affected time-frequency resource participates in decoding performed by the UE on the data scheduled by using the DCI.

When the data scheduled by using the DCI is affected by the PI, the data transmitted on the foregoing affected time-frequency resource may be flushed or excluded in three different processing manners. In a first manner, only the data transmitted on the affected time-frequency resource is flushed. In a second manner, for simplification, data of an entire affected code block (CB) may be flushed. In a third manner, for further simplification, data of an entire affected code block group (CBG) is flushed. The affected CB or CBG herein means that a part of a time-frequency resource used to transmit the CB or the CBG is an affected time-frequency resource. The first processing manner may also be referred to as flushing physical data, and the second and third processing manners may also be referred to as flushing logical data.

As shown in FIG. 5, this application provides a schematic flowchart of a method for preempting a resource to transmit data.

S510. A terminal device receives first control information from a network device, where the first control information is used to indicate that the terminal device receives first data on a first time-frequency resource.

Corresponding to the foregoing scenario 1 and scenario 2, the first control information herein may be the DCI_A or the DCI_B, the first time-frequency resource may be the time-frequency resource A or the time-frequency resource B, and the first data may be the data A or the data B. The first data may be data of one or more transport blocks (TB) in URLLC service data, and may alternatively be data of one or more TBs in eMBB service data.

S520. The terminal device receives second control information, where the second control information is used to indicate that no information is transmitted on a second time-frequency resource. Herein, no information transmission corresponds to a preempted case. When a time-frequency resource of a service 1 is preempted by another service 2, data of the service 2 instead of data of the service 1 is transmitted on the preempted time-frequency resource. Therefore, for the service 1, there is no information transmission.

Corresponding to the foregoing scenario 1 and scenario 2, the second control information herein may be the PI, and the second time-frequency resource may be the time-frequency resource C. Herein, that there is no information transmitted on the second time-frequency resource means that the time-frequency resource C is preempted, the data B transmitted on the time-frequency resource E is punctured, and no data B is transmitted on the corresponding time-frequency resource E, or a power of the data B transmitted on the time-frequency resource E is set to zero.

S530. The terminal device determines, based on a feature of the first control information or a feature of the first data, whether the first data exists on a third time-frequency resource, or the terminal device determines, based on a feature of the first control information or a feature of the first data, whether receiving of the first data is affected by the second control information, where the third time-frequency resource is an overlapped time-frequency resource of the first time-frequency resource and the second time-frequency resource. Further, when the terminal device determines that the first data exists on the third time-frequency resource, the data transmitted on the third time-frequency resource participates in decoding performed by the terminal device on the first data. When the terminal device determines that the first data does not exist on the third time-frequency resource, the data transmitted on the third time-frequency resource does not participate in decoding performed by the terminal device on the first data. For more specific descriptions, refer to the foregoing explanations that data receiving is affected by the PI.

Corresponding to the foregoing scenario 1 and scenario 2, the third time-frequency resource herein may be the time-frequency resource D or the time-frequency resource E.

Specifically, the feature of the first control information includes a type of the first control information or a start transmission location of the first control information.

Optionally, the terminal device determines that the first data exists on the third time-frequency resource when the type of the first control information is a first type. That is, receiving of the first data is not affected by the PI. The terminal device determines that the first data does not on the third time-frequency resource when the type of the first control information is not the first type. That is, receiving of the first data is affected by the PI. For a URLLC service, to improve DCI transmission reliability, compact DCI is usually used. Therefore, the first type herein may be compact DCI. Certainly, the first type may alternatively have another specific type name. A specific name of the first type is not limited in this application. A time-frequency resource scheduled by using first-type DCI is not allowed to be preempted. Correspondingly, receiving of data scheduled by using the first-type DCI is not affected by the PI. A specific value of the first type may be predefined in a protocol, or may be notified by the network device to the terminal device by using signaling after the network device determines the value.

Specifically, whether the type of the first control information is the first type may be determined in at least one of the following manners:

(i) A radio network temporary identifier (RNTI) used for scrambling the first control information is an RNTI of first-type control information.

(2) A payload size of the first control information is equal to a payload size of first-type control information.

(3) A first field in the first control information indicates first-type control information. For example, a name of the first field is Identifier for DCI Formats.

(4) An error probability of the first control information meets a requirement of first-type control information for an error probability. The error probability herein may be a false alarm probability, or may be a missed alarm probability, or may be a combination of a false alarm probability and a missed alarm probability. Specifically, the error probability may be determined through check. For example, the error probability may be determined by using a length of a cyclic redundancy check (CRC) sequence. When the length of the CRC sequence is longer than a threshold, it is considered that the first control information is the first-type control information. Alternatively, the error probability may be determined by using a check step. When the first control information needs to be checked by using two or more steps, it is considered that the first control information is the first-type control information.

(5) When a coding scheme of the first control information is a particular coding scheme, it is determined that the first control information is first-type control information. For example, the coding scheme of the first control information may be one of a low-density parity-check (LDPC) coding or a polar (polar) coding.

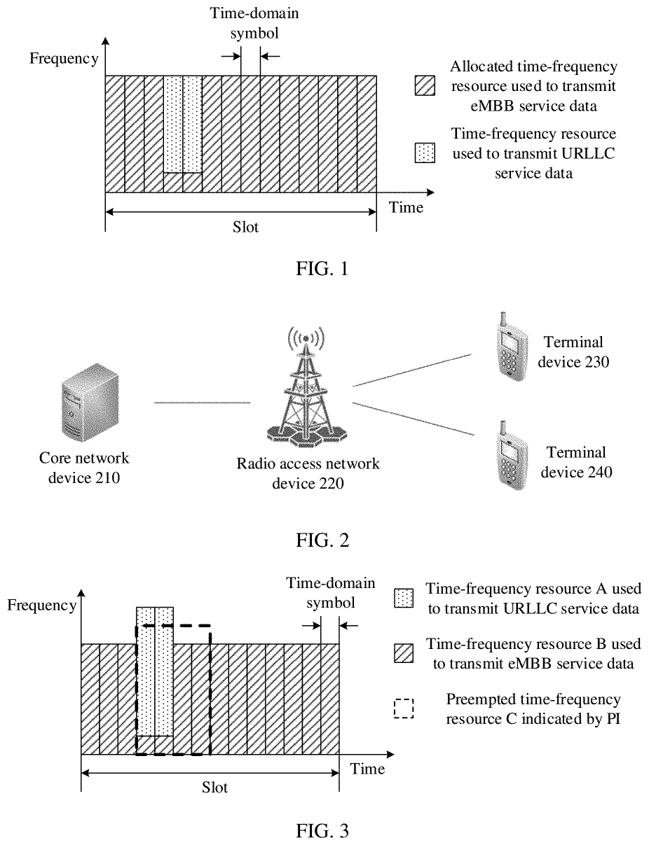

Optionally, the terminal device determines that the first data exists on the third time-frequency resource when the start transmission location of the first control information is not a start location of a slot. That is, receiving of the first data is not affected by the PI. As shown in FIG. 1, when the URLLC service data preempts a time-frequency resource used to transmit the eMBB service data, the start transmission location of the DCI for scheduling the URLLC service data is not a start location of a slot, for example, is a fourth time domain symbol of the slot.

The feature of the first data includes a transmission time interval for transmitting the first data or a subcarrier spacing (SCS) for transmitting the first data.

Optionally, the terminal device determines that the first data exists on the third time-frequency resource when the transmission time interval for transmitting the first data is less than a first threshold. That is, receiving of the first data is not affected by the PI. The terminal device determines that the first data does not exist on the third time-frequency resource when the transmission time interval for transmitting the first data is greater than or equal to the first threshold. That is, receiving of the first data is affected by the PI. Optionally, the terminal device determines that the first data exists on the third time-frequency resource when the transmission time interval for transmitting the first data is less than or equal to the first threshold. That is, receiving of the first data is not affected by the PI. The terminal device determines that the first data does not exist on the third time-frequency resource when the transmission time interval for transmitting the first data is greater than the first threshold. That is, receiving of the first data is affected by the PI. The first threshold may be in a unit of a symbol, and values of the first threshold may be the same in different SCS scenarios. Alternatively, the first threshold may be in a unit of time, and values of the first threshold in different SCS scenarios may be set to different values. The first threshold may be predefined by a system, or may be determined by the network device and then notified to the terminal device by using signaling. In this application, a signaling notification may be radio resource control (RRC) signaling, physical layer signaling, or medium access control signaling. The signaling may be sent to a particular terminal device, or may be group signaling, that is, the signaling is sent to a group of terminal devices; or may be broadcast signaling, that is, the signaling is sent to all terminal devices in a cell.

Optionally, the terminal device determines that the first data exists on the third time-frequency resource when the subcarrier spacing for transmitting the first data is greater than a second threshold. That is, receiving of the first data is not affected by the PI. The terminal device determines that the first data does not exist on the third time-frequency resource when the subcarrier spacing for transmitting the first data is less than or equal to the second threshold. That is, receiving of the first data is affected by the PI. Optionally, the terminal device determines that the first data exists on the third time-frequency resource when the subcarrier spacing for transmitting the first data is greater than or equal to the second threshold. That is, receiving of the first data is not affected by the PI. The terminal device determines that the first data does not exist on the third time-frequency resource when the subcarrier spacing for transmitting the first data is less than the second threshold. That is, receiving of the first data is affected by the PI. The second threshold may be predefined by a system, or may be determined by the network device and then notified to the terminal device by using signaling.

In this embodiment of this application, the terminal device determines, based on the feature of the first control information or the feature of the first data, whether the first data exists on the third time-frequency resource, and implicitly determines receiving processing of the data on the third time-frequency resource, thereby reducing signaling overheads and improving air interface transmission efficiency.

### Embodiment 2

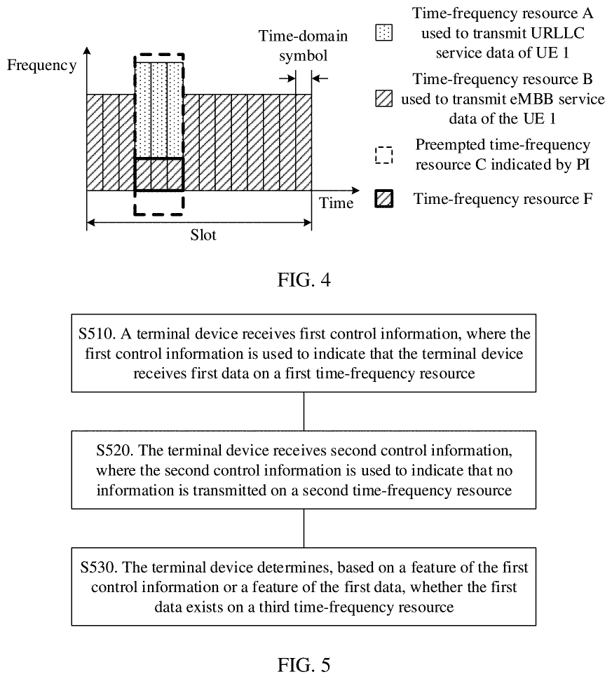

As described in the foregoing scenario 2, the URLLC service data of the UE 1 preempts a transmission resource used to transmit the eMBB service data of the UE 1. An indication granularity of the preempted time-frequency resource C indicated by the PI is relatively coarse. For example, what is indicated is that a time-frequency resource with a granularity of a symbol in time domain and a bandwidth part (BWP) in frequency domain is preempted, or a time-frequency resource with a granularity of a symbol in time domain and a half of a BWP in frequency domain is preempted. In this way, a case shown in FIG. 4 may occur. Although the time-frequency resource C includes all time-frequency resources that are used to transmit the eMBB service data of the UE 1 and that are in a fourth symbol, a fifth symbol, and a sixth symbol. Actually, only a part of the time-frequency resource in the time-frequency resource C is used for the URLLC service data of the UE 1. In the fourth symbol, the fifth symbol, and the sixth symbol, the part of the time-frequency resource used to transmit the eMBB service data of the UE 1 is not preempted, for example, a time-frequency resource F in FIG. 4. In the prior art, the UE 1 can perform a data flush operation only based on the time-frequency resource C. Consequently, although the data on the time-frequency resource F is the eMBB service data, the data is flushed by the UE 1 due to impact of the PI, resulting in deteriorating data transmission performance of the UE 1.

For the scenario 2, the UE 1 may obtain specific locations of the time-frequency resource A, the time-frequency resource B, and the time-frequency resource C, to determine whether the time-frequency resource F exists. However, the UE 1 cannot determine whether a part of or all of the time-frequency resource in the time-frequency resource F is preempted by the URLLC service data of another terminal device. Therefore, the UE 1 cannot determine whether data transmitted on the time-frequency resource F can be reserved. However, the network device knows whether a part of or all of the time-frequency resource in the time-frequency resource F is preempted by URLLC service data of another terminal device, and the network device may notify, in real time by using DCI for scheduling the URLLC service data, the UE 1 of information about whether the time-frequency resource F is preempted by another terminal device. Therefore, the UE 1 may determine whether to flush the eMBB service data on the time-frequency resource F.

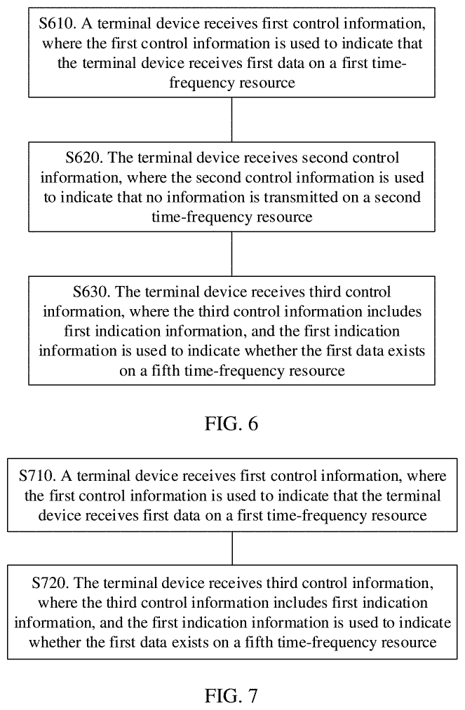

As shown in FIG. 6, this application provides a schematic flowchart of a method for preempting a resource to transmit data.

S610. A terminal device receives first control information from a network device, where the first control information is used to indicate that the terminal device receives first data on a first time-frequency resource.

Corresponding to the foregoing scenario 2, the first control information herein may be the DCI_B, the first time-frequency resource may be the time-frequency resource B, and the first data may be the data B. The first data may be data of one or more TBs in the eMBB service data.

S620. The terminal device receives second control information, where the second control information is used to indicate that no information is transmitted on a second time-frequency resource.

Corresponding to the foregoing scenario 2, the second control information herein may be the PI, and the second time-frequency resource may be the time-frequency resource C. That there is no information transmitted on the second time-frequency resource herein means that the time-frequency resource C is preempted, the data B transmitted on the time-frequency resource E is punctured, and no data B is transmitted on the corresponding time-frequency resource E, or a power of the data B transmitted on the time-frequency resource E is set to zero.

S630. The terminal device receives third control information, where the third control information is used to indicate that the terminal device receives third data on a fourth time-frequency resource; and the third control information includes first indication information, and the first indication information is used to indicate whether the terminal device has the first data on a fifth time-frequency resource, where the fifth time-frequency resource is a time-frequency resource that is of a sixth time-frequency resource and that does not overlap with a third time-frequency resource, the sixth time-frequency resource is an overlapped time-frequency resource of the fourth time-frequency resource and the second time-frequency resource, and the third time-frequency resource is an overlapped time-frequency resource of the first time-frequency resource and the second time-frequency resource.

Further, when the first indication information indicates that the first data exists on the fifth time-frequency resource, the data transmitted on the fifth time-frequency resource participates in decoding performed by the terminal device on the first data. The data transmitted on the fifth time-frequency resource does not participate in decoding performed by the terminal device on the first data when the first indication information indicates that the first data does not exist on the fifth time-frequency resource. For more specific descriptions, refer to the explanation in the foregoing Embodiment 1 that data receiving is affected by the PI.

Corresponding to the scenario 2, the third control information herein is the DCI_A, the fourth time-frequency resource is the time-frequency resource A, and the third data is the data A. The third data is data of one or more transport blocks (TB) of the URLLC service data. The fifth time-frequency resource corresponds to the time-frequency resource F in FIG. 4.

Specifically, the first indication information may be one bit, and is used to indicate whether the first data exists on the fifth time-frequency resource. For example, it indicates that the first data needs to exist on the fifth time-frequency resource when a value of the first indication information is 1. That is, receiving of the first data is not affected by the second control information. It indicates that the first data does not exist on the fifth time-frequency resource when the value of the first indication information is o. That is, receiving of the first data is affected by the second control information. Alternatively, it indicates that the first data needs to exist on the fifth time-frequency resource when the value of the first indication information is o. It indicates that there is no first data on the fifth time-frequency resource when the value of the first indication information is 1.

In a special case of scenario 2, if only the URLLC service data of the UE 1 preempts the eMBB service data of the UE 1 in a time-frequency region corresponding to a reference downlink resource (RDR), the network device may not send the PI. A corresponding embodiment is shown in FIG. 7.

S710. A terminal device receives first control information from a network device, where the first control information is used to indicate that the terminal device receives first data on a first time-frequency resource.

Corresponding to scenario 2, the first control information herein may be the DCI_B, the first time-frequency resource may be the time-frequency resource B, and the first data may be the data B. The first data may be data of one or more TBs in the eMBB service data.

S720. The terminal device receives third control information, where the third control information is used to indicate that the terminal device receives third data on a fourth time-frequency resource; and the third control information further includes first indication information, and the first indication information is used to indicate that whether the terminal device has first data on a fifth time-frequency resource, where time domain of the fifth time-frequency resource corresponds to overlapped time domain of the first time-frequency resource and the fourth time-frequency resource, and frequency domain of the fifth time-frequency resource corresponds to non-overlapped frequency domain of the first time-frequency resource and the fourth time-frequency resource.

Further, the data transmitted on the fifth time-frequency resource participates in decoding performed by the terminal device on the first data when the first indication information indicates that the first data exists on the fifth time-frequency resource. The data transmitted on the fifth time-frequency resource does not participate in decoding performed by the terminal device on the first data when the first indication information indicates that the first data does not exist on the fifth time-frequency resource.

Corresponding to the scenario 2, the third control information herein is the DCI_A, the fourth time-frequency resource is the time-frequency resource A, and the third data is the data A. The third data is data of one or more transport blocks (TB) of the URLLC service data. The fifth time-frequency resource corresponds to the time-frequency resource F in FIG. 4.

Specifically, the first indication information may be one bit, and is used to indicate whether the first data exists on the fifth time-frequency resource. For example, it indicates that the first data needs to exist on the fifth time-frequency resource when the value of the first indication information is 1, that is, the data on the fifth time-frequency resource is not flushed. It indicates that there is no first data on the fifth time-frequency resource when the value of the first indication information is o. Alternatively, it indicates that the first data needs to exist on the fifth time-frequency resource when the value of the first indication information is o. It indicates that there is no first data on the fifth time-frequency resource when the value of the first indication information is 1.

In the embodiments shown in FIG. 6 and FIG. 7, the terminal is an execution body. The terminal device determines, based on the first indication information, whether the terminal device has the first data on the fifth time-frequency resource, and explicitly indicates receiving and processing of the data on the fifth time-frequency resource, to avoid flushing data that can participate in decoding, thereby improving air interface transmission efficiency.

### Embodiment 3

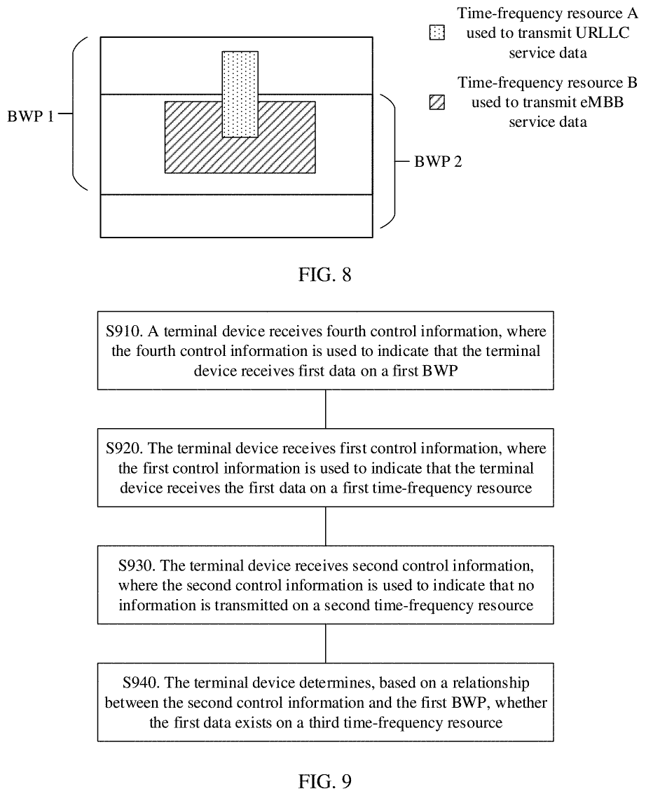

As shown in FIG. 8, UE 1 receives the URLLC service data by using the time-frequency resource A, and receives the eMBB service data by using the time-frequency resource B. The network device configures two BWPs for the UE 1, a BWP 1 for the URLLC service, and a BWP 2 for the eMBB service. In FIG. 8, a part of the time-frequency resource A overlaps the time-frequency resource B, that is, a URLLC service data part preempts the time-frequency resource B. Because a time-frequency resource used to transmit the eMBB service data in the BWP 2 is preempted, the network device sends the PI corresponding to the BWP 2, or sends the PI in the BWP 2. Correspondingly, after receiving the PI in the BWP 2, the UE 1 determines, based on the PI, that the time-frequency resource used to transmit the eMBB service data is preempted. However, the UE 1 does not determine, based on the PI in the BWP 2, that the time-frequency resource used to transmit the URLLC service data is preempted, because the URLLC service belongs to the BWP 1 and does not belong to the BWP 2. Therefore, the UE 1 cannot determine, based on the PI in the BWP 2, a case in which the time-frequency resource used to transmit service data in the BWP 1 is preempted. If the network device does not configure a PI-related resource or start a PI mechanism in the BWP 1, the UE may consider that a time-frequency resource of service data belonging to the BWP 1 is not preempted.

In the foregoing description, the BWP configuration may be adding an indication field to the DCI for scheduling data, to indicate a BWP to which the currently scheduled data belongs, or adding an indication field to indicate a BWP to which data scheduled n times belongs, where n is a positive integer.

As shown in FIG. 9, this application provides a schematic flowchart of a method for preempting a resource to transmit data.

S910. A terminal device receives fourth control information from a network device, where the fourth control information is used to indicate that the terminal device receives first data on a first BWP.

For example, the network device allocates, to the UE1, a BWP 1 to transmit the URLLC service data, and/or allocates a BWP 2 to transmit the eMBB service data. The fourth control information may be carried by using RRC signaling or physical layer signaling.

S920. The terminal device receives first control information from the network device, where the first control information is used to indicate that the terminal device receives the first data on a first time-frequency resource.

Corresponding to the foregoing scenario 1 and scenario 2, the first control information herein may be the DCI_A or the DCI_B, the first time-frequency resource may be the time-frequency resource A or the time-frequency resource B, and the first data may be the data A or the data B. The first data may be data of one or more transport blocks (TB) in URLLC service data, and may alternatively be data of one or more TBs in eMBB service data.

S930. The terminal device receives second control information, where the second control information is used to indicate that no information is transmitted on a second time-frequency resource.

Corresponding to the foregoing scenario 1 and scenario 2, the second control information herein may be the PI, and the second time-frequency resource may be the time-frequency resource C. That there is no information transmitted on the second time-frequency resource herein means that the time-frequency resource C is preempted, the data B transmitted on the time-frequency resource E is punctured, and no data B is transmitted on the corresponding time-frequency resource E, or a power of the data B transmitted on the time-frequency resource E is set to zero.

S940. The terminal device determines, based on a relationship between the second control information and the first BWP, whether the first data exists on a third time-frequency resource, or the terminal device determines, based on a relationship between the second control information and the first BWP, whether receiving of the first data is affected by the second control information, where the third time-frequency resource is an overlapped time-frequency resource of the first time-frequency resource and the second time-frequency resource. Further, the data transmitted on the third time-frequency resource participates in decoding performed by the terminal device on the first data when the terminal device determines that the first data exists on the third time-frequency resource. The data transmitted on the third time-frequency resource does not participate in decoding performed by the terminal device on the first data when the terminal device determines that the first data does not exist on the third time-frequency resource. For more specific descriptions, refer to the explanation in the foregoing Embodiment 1 that data receiving is affected by the PI.

Corresponding to the foregoing scenario 1 and scenario 2, the third time-frequency resource herein may be the time-frequency resource D or the time-frequency resource E, and the second data is the data A transmitted on the time-frequency resource D or the data B transmitted on the time-frequency resource E.

Specifically, the terminal device determines that the first data does not exist on the third time-frequency resource when the second control information corresponds to the first BWP, or the second control information belongs to the first BWP. The terminal device determines that the first data exists on the third time-frequency resource when the second control information does not correspond to the first BWP, or the second control information does not belong to the first BWP.

An application scenario of Embodiment 3 is not limited to scenario 1 or scenario 2, and may alternatively be another application scenario. More generally, receiving of data scheduled by using the DCI is not affected by the PI belonging to different BWPs. For example, data scheduled by using DCI 1 belongs to the BWP 1. If the PI does not belong to the BWP 1, data scheduled by using the DCI 1 is not affected by the PI.

In the foregoing embodiment provided in this application, the data transmission method provided in this embodiment of this application is described from a perspective of the terminal device. It may be understood that, to implement the foregoing functions, the terminal device includes a corresponding hardware structure and/or software module for performing the functions. A person of ordinary skill in the art should easily be aware that, in combination with the examples described in the embodiments disclosed in this specification, units, methods steps may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

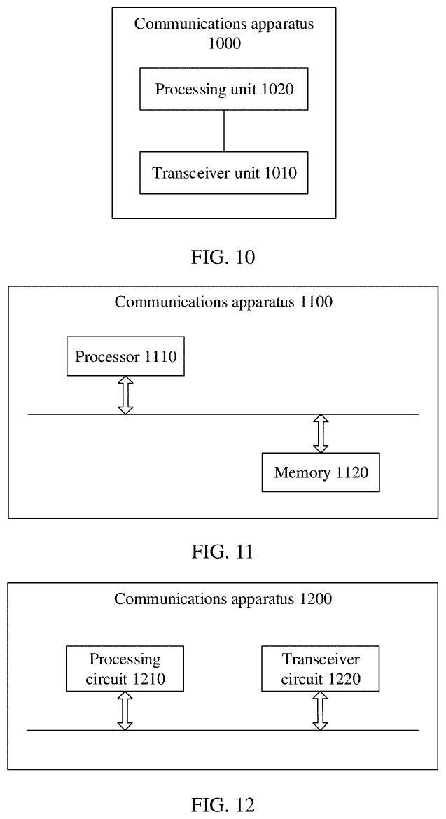

FIG. 10, FIG. 11, and FIG. 12 are schematic structural diagrams of three possible communications apparatuses according to embodiments of this application. The communications apparatus implements functions of the terminal device in the foregoing method embodiments described above, and therefore can also implement beneficial effects of the method embodiments. In this embodiment of this application, the communications apparatus may be the terminal device 230 or the terminal device 240 shown in FIG. 2, or may be a chip applied to the terminal device.

As shown in FIG. 10, a communications apparatus 1000 includes a transceiver unit 1010 and a processing unit 1020.

Based on related descriptions of the foregoing method Embodiment 1, the following apparatus embodiment corresponding to the method Embodiment 1 may be obtained.

The transceiver unit 1010 is configured to receive first control information, where the first control information is used to indicate that the transceiver unit 1010 receives first data on a first time-frequency resource.

The transceiver unit 1010 is further configured to receive second control information, where the second control information is used to indicate that no information is transmitted on a second time-frequency resource.

The processing unit 1020 is configured to determine, based on a feature of the first control information or a feature of the first data, whether the first data exists on a third time-frequency resource, where the third time-frequency resource is an overlapped time-frequency resource of the first time-frequency resource and the second time-frequency resource.

The processing unit 1020 is further configured to receive third control information, where the third control information is used to indicate that the transceiver unit 1010 receives third data on a fourth time-frequency resource; and the third control information includes first indication information, and the first indication information is used to indicate whether there is the first data sent to the communications apparatus on a fifth time-frequency resource, where the fifth time-frequency resource is a time-frequency resource that is of a sixth time-frequency resource and that does not overlap with the third time-frequency resource, and the sixth time-frequency resource is an overlapped time-frequency resource of the fourth time-frequency resource and the second time-frequency resource.

Based on related descriptions of the foregoing method embodiment 3, the following apparatus embodiment corresponding to the method embodiment 3 may be obtained.

The transceiver unit 1010 is configured to receive fourth control information, where the fourth control information is used to indicate that the transceiver unit 1010 receives first data on a first bandwidth part BWP.

The transceiver unit 1010 is further configured to receive first control information, where the first control information is used to indicate that the transceiver unit 1010 receives the first data on a first time-frequency resource.

The transceiver unit 1010 is further configured to receive second control information, where the second control information is used to indicate that no information is transmitted on a second time-frequency resource.

The processing unit 1020 is configured to determine, based on a relationship between the second control information and the first BWP, whether the first data exists on a third time-frequency resource, where the third time-frequency resource is an overlapped time-frequency resource of the first time-frequency resource and the second time-frequency resource.

Based on related descriptions of the second method embodiment, an apparatus embodiment corresponding to the method Embodiment 2 may be obtained, and details are not described herein.

For more detailed descriptions of the transceiver unit 1010 and the processing unit 1020, directly refer to the foregoing method embodiments. Details are not described herein.

As shown in FIG. 11, a communications apparatus 1100 includes a processor 1110 and a memory 1120. The memory 1120 is configured to store a computer program or an instruction. The processor 1110 is configured to execute the computer program or the instruction stored in the memory. When the processor 1110 executes the computer program or the instruction stored in the memory 1120, the communications apparatus 1100 is configured to implement the method in the method embodiments. Components in the communications apparatus 1100 communicate with each other by using an internal connection path, for example, transfer a control and/or data signal by using a bus. A quantity of processors 1110 and memories 1120 that are included in the communications apparatus 1100 is not limited in this embodiment of this application.

As shown in FIG. 12, a communications apparatus 1200 includes a processing circuit 1210 and a transceiver circuit 1220. The processing circuit 1210 is configured to perform a function of the foregoing processing unit 1010, and the transceiver circuit 1220 is configured to perform a function of the foregoing transceiver unit 1020. Circuits in the communications apparatus 1200 communicate with each other by using an internal circuit.

When the foregoing communications apparatus is a chip of a terminal device, the chip of the terminal device implements functions of the terminal device in the foregoing method embodiments. The terminal device chip receives information from another module (for example, a radio frequency module or an antenna) in the terminal device, and the information is sent by the network device to the terminal device.

In the embodiments of this application, unless otherwise specified, terms and descriptions in different embodiments are consistent and may be mutually referenced. Technical features in different embodiments may be combined based on an internal logical relationship of the technical features to form a new embodiment.

It should be noted that the processor in the embodiments of this application may be a central processing unit (CPU), may be another general-purpose processor, a digital signal processor (DSP), an application specific integrated circuit (ASIC), a field programmable gate array (FPGA), or another programmable logical device, a transistor logical device, a hardware component, or any combination thereof. A general-purpose processor may be a microprocessor or any conventional processor or the like.

The method steps in the embodiments of this application may be implemented by hardware, or may be implemented by a processor by executing a software instruction. The software instruction may include a corresponding software module. The software module may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium well-known in the art. For example, a storage medium is coupled to a processor, so that the processor can read information from the storage medium or write information into the storage medium. Certainly, the storage medium may be a component of the processor. The processor and the storage medium may be located in the ASIC. In addition, the ASIC may be located in a sending device or a receiving device. Certainly, the processor and the storage medium may exist in a sending device or a receiving device as discrete components.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instruction may be stored in a computer readable storage medium, or may be transmitted by using the computer readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a soft disk, a hard disk, or a magnetic tape), an optical medium (for example, a digital versatile disc (DVD)), a semiconductor medium (for example, a solid-state disk (SSD)), or the like.

In this application, “a plurality of” means two or more than two. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally represents an “or” relationship between the associated objects, and the character “/” in a formula represents a “division” relationship between the associated objects.

It may be understood that numbers in the embodiments of this application are merely for differentiation for ease of description, and are not intended to limit the scope of the embodiments of this application.

It should be understood that sequence numbers of the foregoing processes do not mean execution sequences in the embodiments of this application. The execution sequences of the processes should be determined according to functions and internal logic of the processes, and should not be construed as any limitation on the implementation processes of the embodiments of this application.

The foregoing descriptions are merely specific implementations of the embodiments of this application. Any variation or replacement readily figured out by a person skilled in the art within the technical scope disclosed in this application shall fall within the protection scope in the embodiments of this application.

1.-18. (canceled)

19. A method, comprising:
receiving first control information, wherein the first control information indicates that a communications apparatus is configured to receive first data on a first time-frequency resource;
receiving second control information, wherein the second control information indicates that no information is transmitted on a second time-frequency resource; and
determining, based on a feature of the first control information or a feature of the first data, whether the first data exists on a third time-frequency resource, wherein the third time-frequency resource is an overlapping time-frequency resource of the first time-frequency resource and the second time-frequency resource.

20. The method according to claim 19, wherein the feature of the first control information comprises a type of the first control information, and determining, based on the feature of the first control information, whether the first data exists on the third time-frequency resource comprises:
determining that the first data exists on the third time-frequency resource in response to the type of the first control information being a first type; or
determining that the first data does not exist on the third time-frequency resource in response to the type of the first control information not being the first type.

21. The method according to claim 20, further comprising:
receiving third control information, wherein the third control information indicates that the communications apparatus is configured to receive third data on a fourth time-frequency resource; and
wherein the third control information comprises first indication information, and the first indication information indicates whether the first data will be sent to the communications apparatus on a fifth time-frequency resource, wherein the fifth time-frequency resource is a time-frequency resource that is comprised in a sixth time-frequency resource and that does not overlap with the third time-frequency resource, and the sixth time-frequency resource is an overlapping time-frequency resource of the fourth time-frequency resource and the second time-frequency resource.

22. The method according to claim 19, wherein the feature of the first control information comprises a start transmission location of the first control information, and determining, based on the feature of the first control information, whether the first data exists on the third time-frequency resource comprises:
determining that the first data exists on the third time-frequency resource in response to the start transmission location of the first control information not being a start location of a slot.

23. The method according to claim 19, wherein the feature of the first data comprises a transmission time interval usable to transmit the first data, and determining, based on the feature of the first data, whether the first data exists on the third time-frequency resource comprises:
determining that the first data exists on the third time-frequency resource in response to the transmission time interval usable to transmit the first data being shorter than a first threshold; or
determining that the first data does not exist on the third time-frequency resource in response to the transmission time interval usable to transmit the first data being longer than or equal to the first threshold.

24. The method according to claim 19, wherein the feature of the first data comprises a subcarrier spacing usable to transmit the first data, and determining, based on the feature of the first data, whether the first data exists on the third time-frequency resource comprises:
determining that the first data exists on the third time-frequency resource in response to the subcarrier spacing usable to transmit the first data being greater than a second threshold; or
determining that the first data does not exist on the third time-frequency resource in response to the subcarrier spacing usable to transmit the first data being less than or equal to the second threshold.

25. An apparatus, comprising:
a non-transitory memory storing instructions; and
one or more processors coupled to the non-transitory memory, wherein the one or more processors are configured to execute the instructions, and the instructions comprise instructions to:
receive first control information, wherein the first control information indicates that first data will be received on a first time-frequency resource,
receive second control information, wherein the second control information indicates that no information is transmitted on a second time-frequency resource; and
determine, based on a feature of the first control information or a feature of the first data, whether the first data exists on a third time-frequency resource, wherein the third time-frequency resource is an overlapping time-frequency resource of the first time-frequency resource and the second time-frequency resource.

26. The apparatus according to claim 25, wherein the instructions comprise instructions to:
determine that the first data exists on the third time-frequency resource in response to the type of the first control information being a first type; or
determine that the first data does not exist on the third time-frequency resource in response to the type of the first control information not being the first type.

27. The apparatus according to claim 26, wherein the instructions further comprise instructions to:
receive third control information, wherein the third control information indicates that the apparatus is configured to receive third data on a fourth time-frequency resource; and
wherein the third control information comprises first indication information, and the first indication information indicates whether the first data will be sent to the apparatus on a fifth time-frequency resource, wherein the fifth time-frequency resource is a time-frequency resource that is of a sixth time-frequency resource and that does not overlap with the third time-frequency resource, and the sixth time-frequency resource is an overlapping time-frequency resource of the fourth time-frequency resource and the second time-frequency resource.

28. The apparatus according to claim 25, wherein the instructions comprise instructions to:
determine that the first data exists on the third time-frequency resource in response to a start transmission location of the first control information not being a start location of a slot.

29. The apparatus according to claim 25, wherein the instructions comprise instructions to:
determine that the first data exists on the third time-frequency resource in response to a transmission time interval usable to transmit the first data being shorter than a first threshold; or
determine that the first data does not exist on the third time-frequency resource in response to the transmission time interval usable to transmit the first data being longer than or equal to the first threshold.

30. The apparatus according to claim 25, wherein the instructions comprise instructions to:
determine that the first data exists on the third time-frequency resource in response to a subcarrier spacing usable to transmit the first data being greater than a second threshold; or
determine that the first data does not exist on the third time-frequency resource in response to the subcarrier spacing usable to transmit the first data being shorter than or equal to the second threshold.

31. A non-transitory computer-readable medium storing a program for use by a processor of a terminal device, wherein the program comprises instructions for:
receiving first control information, wherein the first control information indicates that an apparatus is configured to receive first data on a first time-frequency resource,
receiving second control information, wherein the second control information indicates that no information is transmitted on a second time-frequency resource; and
determining, based on a feature of the first control information or a feature of the first data, whether the first data exists on a third time-frequency resource, wherein the third time-frequency resource is an overlapping time-frequency resource of the first time-frequency resource and the second time-frequency resource.

32. The non-transitory computer-readable medium according to claim 31, wherein the program comprises instructions for:
determining that the first data exists on the third time-frequency resource in response to the type of the first control information being a first type; or
determining that the first data does not exist on the third time-frequency resource in response to the type of the first control information not being the first type.

33. The non-transitory computer-readable medium according to claim 32, wherein the program further comprises instructions for:
receive third control information, wherein the third control information indicates that the apparatus is configured to receive third data on a fourth time-frequency resource; and
wherein the third control information comprises first indication information, and the first indication information indicates whether the first data will be sent to the apparatus on a fifth time-frequency resource, wherein the fifth time-frequency resource is a time-frequency resource that is of a sixth time-frequency resource and that does not overlap with the third time-frequency resource, and the sixth time-frequency resource is an overlapping time-frequency resource of the fourth time-frequency resource and the second time-frequency resource.

34. The non-transitory computer-readable medium according to claim 31, wherein the program comprises instructions for:
determining that the first data exists on the third time-frequency resource in response to a start transmission location of the first control information not being a start location of a slot.

35. The non-transitory computer-readable medium according to claim 31, wherein the program comprises instructions for:
determining that the first data exists on the third time-frequency resource in response to a transmission time interval usable to transmit the first data being shorter than a first threshold; or
determining that the first data does not exist on the third time-frequency resource in response to the transmission time interval usable to transmit the first data being greater than or equal to the first threshold.

36. The non-transitory computer-readable medium according to claim 31, wherein the program comprises instructions for:
determining that the first data exists on the third time-frequency resource in response to a subcarrier spacing usable to transmit the first data being greater than a second threshold; or
determining that the first data does not exist on the third time-frequency resource in response to the subcarrier spacing usable to transmit the first data being less than or equal to the second threshold.
